(19) United States
(12) Patent Application Publication
(10) Pub. No.: US 2023/0159079 A1
(43) Pub. Date: May 25, 2023

(54) CHILD TRANSPORTATION SYSTEM

(71) Applicant: STROLLEAZI GROUP LIMITED, London (GB)

(72) Inventors: Emma Lawrence, London (GB); Jesper Tyrer, London (GB)

(73) Assignee: STROLLEAZI GROUP LIMITED, London (GB)

(21) Appl. No.: 18/008,096

(22) PCT Filed: Jun. 4, 2021
(86) PCT No.: PCT/GB2021/051398

§ 371 Date: Dec. 2, 2022

(30) Foreign Application Priority Data
Jun. 4, 2020 (GB) 2008434.9
Mar. 12, 2021 (GB) 2103493.9

(51) Int. Cl. B62B 7/06; B62B 7/14; B62B 7/08; B62B 9/10; B62B 9/20; B60N 2/28

(52) U.S. Cl. CPC B62B 7/062; B62B 7/064; B62B 7/142; B62B 7/145; B62B 7/08; B62B 9/104; B62B 9/20; B60N 2/2845; B62B 2205/104; B62B 2205/22; B62B 2206/02; B62B 2301/05

(57) ABSTRACT

A pram may be used to transport babies and relatively young infants, and may provide a relatively horizontal surface for the baby or infant to be transported upon in a flat lying position. A pram may also be used to transport relatively older infants, and may provide a seat arrangement for the infant to be transported in a sitting position. However, babies and infants grow quickly and may outgrow conventional prams within a year or two years. Therefore, a parent or guardian must typically provide several prams for their child. Furthermore, a pram offering optimal comfort or safety may not be convenient when travelling or for city living. An aspect of the present disclosure includes a child transportation system comprising a frame 100, wherein the frame 100 is width adjustable between a relatively narrow compact arrangement and a relatively wide comfort arrangement. The frame 100 also includes an infant carrier attachment mechanism 500 configured and arranged to permit, in use, a seat 200 or an infant carrier module 300 to be releasably attached to the frame 100.

### FIELD OF THE DISCLOSURE

The present disclosure relates generally to a child transportation system and finds particular, although not exclusive, utility in providing a child transportation system that is adaptable to the needs of a parent or guardian and their child as the child grows, including but not limited to a width adjustable pram and/or stroller.

### BACKGROUND

Parents and guardians of children typically make use of a perambulator, typically and hereinafter called a pram, to transport a child. The term “pram” used herein if intended to be a reference to a perambulator, buggy, pushchair, stroller, umbrella folding stroller or carriage. A pram may be used to transport babies and relatively young infants, and may provide a relatively horizontal surface for the baby or infant to be transported upon in a flat lying position. A pram may also be used to transport relatively older infants, and may provide a seat arrangement for the infant to be transported in a sitting position.

Furthermore, in some countries, it is a legal requirement for babies, infants and children under a certain age and/or height to be provided with a supplemental car seat when travelling in a vehicle. Such car seats typically improve the child's safety when travelling in a vehicle, particularly in a collision scenario, when compared to the use of a typical seat belt alone. The shape, size and arrangement of the car seat is typically dependent on the child's age and/or height. A child may be required to use a so-called baby car seat from birth until approximately 1 year old, a so-called toddler car seat from approximately 1 year old to approximately 4 years old, and a so-called booster seat from approximately 4 years old until the child no longer requires the use of a child specific car seat.

However, babies and infants grow quickly and may outgrow conventional car seats and prams within a year or two years. Therefore, a parent or guardian must typically provide several car seats and prams for their child. Furthermore, a pram offering optimal comfort or safety may not be convenient when travelling or for city living.

Aspects of the present disclosure seek to provide a child transportation system that can be used as a child grows from infant to a toddler and older, typically up to 6 years old. The invention also seeks to provide a versatile arrangement in which components of a car seat system can be used in combination as part of an adaptable pram and stroller system.

### SUMMARY

According to a first aspect of the present disclosure, there is provided a child transportation system comprising a frame, wherein the frame comprises: a first frame member telescopically attached to a second frame member; a rear wheel set and a front wheel set; and an infant carrier attachment mechanism configured and arranged to permit, in use, an infant carrier module to be releasably attached to the frame or a seat; wherein the first frame member is telescopically moveable relative to the second frame member to adjust a width of the frame between a compact arrangement, in which the frame has a first width, and a comfort arrangement, in which the frame has a second width greater than the first width.

A key advantage of the child car seat system is that the frame may be selectively arranged in the compact mode for travel or city living, and in the comfort mode to provide a more comfortable experience for the infant. Furthermore, a component of a car seat system or other such system arranged to carry an infant may be docked on the wheeled frame via the infant carrier attachment mechanism to form a pram. In this way, an infant need not be removed from their seat to move the infant from a vehicle car seat to a pram.

The system may be adjusted to suit the needs of an infant. Accordingly, there is no need to provide additional components to continue use of the system with the growing child. Additionally, there is no need to dispose of components or systems as the child grows as is typical in this industry, thereby providing a more sustainable system. Furthermore, as the system is adaptable to the needs of a growing infant, the system may have a relative long usable life when compared to typical prams and strollers.

The child transportation system may further comprise an infant carrier module configured to receive an infant therein. The infant carrier module may comprise a frame attachment mechanism configured to interconnect with the infant carrier attachment mechanism to releasably attach the infant carrier module to the frame or seat. The infant carrier module may comprise a seat portion, a backrest portion, a connector portion there between and a locking hinge, wherein the locking hinge is securable in at least two positions such that the seat portion and the backrest portions are relatively positionable in at least two angles. In this way, the infant may be reclined or may lie flat, as well as sit upright. The upright position may provide a comfortable sitting position for the infant and the lie flat position may mimic or provide similar conditions to a bassinet. Accordingly, a more flexible system may be provided, potentially eradicating the need for a parent or guardian to provide different systems or modules.

The frame attachment mechanism may comprise a first socket on a first side of the infant carrier module and a second socket on a second side of the infant carrier module. Each socket may be configured to receive and releasably retain a protrusion of the infant carrier attachment mechanism therein. The sockets on the infant carrier module may connect to the seat, and in particular to a bumper bar housing of the seat. Accordingly, an integrated system may be provided.

The term “infant” used herein may refer to a toddler or a child. The term “pram” used herein if intended to be a reference to a perambulator, buggy, pushchair, stroller, umbrella folding stroller or carriage.

The frame may be arrangeable in a third position. When arranged in the third position, the frame may have a width greater than that of the compact and comfort arrangements. The system may comprise a second seat structure such as a second infant carrier module, a second seat, or a combination thereof. The two seat structures may be arrangeable in a side-by-side arrangement, optionally with a connecting member between the two seat structures, or a tandem arrangement. Alternatively, a relatively large single seat structure may be provided that is suitable for use by two or more infants. Accordingly, with the frame in the third position, the system may be suitable to transport two or more infants, such as siblings.

The first and second frame members may be left and right halves of the frame. Alternatively, the first and second frame members may be frame sub portions, such as left and right handle portions. The frame may comprise a plurality of tubular frame members. The frame members may comprise a plastic, a metal, a combination of plastics and metals, or any other known material. Frame members being telescopically attached may mean than one frame member may be slidably received within another frame member.

The frame may comprise a handle. The handle may include a first handle portion attached to the first and second frame members and a second handle portion telescopically attached to the first handle portion such that the handle is height adjustable. The second handle portion may be configured to be held by a user to manoeuvre the child transportation system. The second handle portion may be releasably securable relative to the first handle portion at a plurality of positions via a handle lock. In this way, the height of the handle may be adjusted according to the preferences of a user. The second handle portion may further comprise a handle release actuator operable to selectively release and engage the handle lock. Accordingly, a user may adjust the height of the handle by actuating the handle release actuator.

The handle release actuator may comprise a rotatable handle portion. The rotatable handle portion may be rotatable between a locking position, in which the handle lock prevents height adjustment of the handle, and a height release position, in which the handle lock is disengaged and the handle is height adjustable. In this way, a user may adjust the height of the handle by rotating the rotatable handle portion into the height release position, rearrange the first and second handle portions, and rotate the rotatable handle portion back into the locking position to secure the handle at the desired height. The rotatable handle portion may be rotatable through approximately 15° to 120°, approximately 30° to 90°, approximately 45° to 75°, such as through 60°, when moving between the locking and height release positions. The handle lock may comprise at least one latch pin configured to engage with the first and second handle portions to prevent relative movement of the first and second handle portions when the release actuator is arranged in the locking position. Rotation of the rotatable handle portion from the locking position to the height release position may pull or retract the at least one latch pin, via a connection member such as a wire, away from the first or second handle portion such that relative movement of the first and second handle portions is possible. Accordingly, the rotatable handle portion may be provided away from the latch pin in a position more preferable for a user.

The first handle portion may be attached to the first and second frame members via a handle hinge. The handle hinge may be configurable in a first orientation, in which the handle is extended, and a second orientation, in which the handle is folded. In this way, the handle may be folded or collapsed, when not in use. The handle hinge may comprise a handle hinge lock operable to releasably secure the handle hinge in the first orientation. The rotatable handle portion may be further rotatable to a fold release position, in which movement of the handle hinge from the first position to the second position is possible. As such, a single actuator may be provided to allow a user to both fold and adjust the height of the handle. Movement of the handle hinge from the first position to the second position may be prevented when the rotatable handle portion is arranged in the locking position. In this way, with the rotatable handle portion arranged in the locking position, both folding and height adjustment of the handle may be prevented.

The rotatable handle portion may be rotatable from the height release position to the fold release position by rotating the rotatable handle portion away from the locking position. The handle release actuator may further comprise a secondary lock. The secondary lock may be moveable, such as slidable or otherwise reconfigurable, between a lock position, in which rotation of the rotatable handle portion from the height release position to the fold release position is prevented, and a release position, in which rotation of the rotatable handle portion from the height release positon to the fold release position is possible. In this way, accidental rotation from the height release position to the fold release position may be prevented. Rotation of the rotatable handle portion from the height release position to the fold release position may disengage the handle hinge lock via a connection member, such as a wire. Accordingly, the rotatable handle portion may be positioned away from the handle hinge lock. The secondary lock may be moveable to the release position only when the handle is arranged in a lowest possible height position.

The child transportation system may further comprise a width adjustment lock operable to selectively prevent relative movement of the first and second frame portions, and any other frame portions. The width adjustment lock may be configured to secure the first and second frame portions in at least two relative positions. In this way, the frame may be secured in a plurality of widths. The child transportation system may further comprise a width adjustment release actuator operable to selectively release and engage the width adjustment lock. The width adjustment release actuator may be positioned on the second handle portion. The width adjustment release actuator may be adjacent to the rotatable handle portion. In this way, the handle adjustment actuator and the width adjustment actuator may be provided in the same location on the handle. The width adjustment release actuator may be provided in two parts, with one part provided on each side of the rotatable handle portion. The width adjustment release actuator may be rotatable between a width unlock position, in which the width lock is disengaged and relative movement of the first and second frame members is possible, and a width lock position, in which the width lock is engaged and relative movement of the first and second frame members is prevented. The width adjustment release actuator may be rotatable through approximately 45° to 75°, such as through 60°

Each of the first and second frame members may include an upper sub portion attached to the handle, a front sub portion attached to a wheel of the front wheel set and a rear sub portion attached to a wheel of the rear wheel set. Each sub portion of the first and second frame members may each be attached via a first and second side joint mechanism respectively. In this way, the frame may be collapsible by operating the first and second side joints. The first and second side joint mechanisms may comprise the handle hinge. Accordingly, all components may hinge about the same point when collapsing the frame. The handle may be fixedly attached to the upper sub portions of the first and second frame members. Accordingly, the handle may be collapsed by rotating the upper sub portions.

The frame may be configurable in an extended arrangement, in which the sub portions are spaced and the system is suitable for transporting an infant, and a collapsed position, in which the sub portions are adjacent along their lengths and the system is arranged for storage. Accordingly, the system may be arranged for use or for storage or travel.

The frame may further comprise a carry handle arranged such that, with the frame in the collapsed position, the carry handle is positioned on an opposite side of the frame to the first and second wheel sets such that the system is manoeuvrable on the first and second wheel sets by pushing or pulling the carry handle. A user may wheel the system along whilst holding the carry handle. The carry handle may also be conveniently positioned for lifting the system whilst in the collapsed arrangement. The carry handle may be positioned under the seat structure. In this way, the carry handle may be hidden from view in ordinary use of the system, but conveniently located when the frame is collapsed. The carry handle may be telescopic, foldable or otherwise adjustable in length. Accordingly, when the frame is in the collapsed position, the user may position the carry handle at a comfortable height such that the user may push or pull the carry handle to wheel the system along the ground.

The front sub portion of the first frame member may be attached to the front sub portion of the second frame member via a front cross member. The rear sub portion of the first frame member may be attached to the rear sub portion of the second frame member via a rear cross member. The front cross member and the rear cross member may be telescopically length adjustable. In this way, the front and rear cross members may facilitate width adjustment of the frame. The front cross member and the rear cross member may each comprise locks configured to selectively prevent length adjustment of the respective cross member. The locks may be rotatably or otherwise actuable to allow for telescopic length adjustment of the cross members. The cross members may provide stability to the frame.

The side joint mechanisms may comprise the infant carrier attachment mechanism or a further infant carrier attachment mechanism. In this way, the infant carrier module may attach and be held adjacent to a middle of the frame, which may provide a relatively strong and stable support to the infant carrier module. Alternatively, or additionally, the seat structure may comprise the infant carrier attachment mechanism. In particular, the bumper bar plug or socket on the seat may include the infant carrier attachment mechanism.

The infant carrier attachment mechanism may comprise a protrusion configured to be received, in use, by a corresponding integrated socket on said infant carrier module. The child transportation system may further comprise seat structure adapters configured to be attachment between the frame and the seat structure when the frame is arranged in the relatively wide arrangement. Accordingly, a single fixed width seat structure may be used regardless of the width setting of the frame.

The child transportation system may further comprise infant carrier adapters configured to be attachable to the infant carrier attachment mechanism to reduce a distance between a first side of the infant carrier attachment mechanism and a second side of the infant carrier attachment mechanism. The adapters may be used when the frame is arranged in the relatively wide comfort mode. The adapters may effectively extend the infant carrier mechanism or provide new attachment points.

The child transportation system may further comprise a seat portion releasably attachable to the infant carrier attachment mechanism. The seat portion may be configurable to, in use, provide a seat structure for an infant. The seat structure may be separate from the infant carrier module. The seat portion may comprise a secondary attachment mechanism configured to releasably attach said infant carrier module thereto, in use. In this way, several seating options may be provided such that a more preferable option may be chosen, particularly depending on the age and/or size of the infant.

The seat portion may comprise a bumper bar configured to be releasably attachable to the secondary attachment mechanism. The infant carrier module may be attachable to the frame or seat via bumper bar attachment points. As such, the bumper bar attachment points may be preferably used for several attachment purposes, negating the need for further dedicated attachment mechanisms.

The bumper bar may be rotatably attached to the frame or seat. The seat portion may comprise a backrest bar rotatably attached to the frame or to a further component of the seat, such as a side housing, and connected to the bumper bar via a gear drive. Adjustment of the bumper bar or the backrest bar may move the other of the bumper bar and the backrest bar via the gear drive. The gear drive may be configured such that a relative angle between the backrest bar and the bumper bar is selectively maintained at all orientations of the bumper bar. As such, the gear drive may connect the bumper bar and the backrest bar such that the bumper bar and backrest bar are always provided in relatively preferred positions.

The backrest bar may comprise a canopy including a shade member. The canopy may be releasably attachable to the backrest bar. Alternatively, the canopy may be releasably attachable to another component of the system. The canopy may be moveable between a stowed position, in which the shade member is retracted, and an extended position, in which the shade member is extended and is configured to, in use, provide a shelter for an infant being transported. The shade member may be waterproof or water resistant.

The seat structure may comprise a leg rest. The leg rest may be securable in a plurality of angular orientations relative to a lower seat member of the seat portion. In this way, a leg rest or foot rest may be provided to the infant in a preferable position. Accordingly, the system may be adjusted depending on the needs of the infant, which may change over time.

The leg rest may be curved, looped or otherwise wrap around a front of the seat structure. In particular, with the infant carrier module attached to the seat structure, the leg rest may wrap around and/or cocoon a lower or other portion of the infant carrier module. The leg rest may comprise a cover configured to enclose at least the infant's legs and provide a so-called cosy toes arrangement. Accordingly, there may be no need to provide an additional pram bassinet, as is typical, such that a more sustainable and/or a more environmentally friendly system is provided.

The seat portion may be arrangeable in an extended position, in which the seat structure is deployed, and a collapsed position, in which the seat structure is collapsed or stowed. In this way, the seat may be collapsed for storage or for travel and does not necessarily need to be detached from the frame for folding.

A first front wheel of the front wheel set may be releasably attached to the first frame member. A second front wheel of the front wheel set may be releasably attached to the second frame member. The child transportation system may further comprise replacement front wheels having a different width and/or diameter to the first and second front wheels. As such, the front wheels may be replaced for replacement wheels that are larger, smaller, more lightweight, more stable or otherwise preferably for a particular scenario or infant.

The front and/or rear wheel sets may comprise a suspension system. The respective wheel may be attached to the respective frame member via a wheel hinge and the suspension system may comprise a dampened spring. In this way, a more comfortable environment may be provided for the infant.

The rear wheel set may comprise two rear wheels connected via a rear axle. The two rear wheels and the axle may be releasably attached to the first and second frame members. The child transportations system may further comprise a replacement rear wheel set comprising replacement rear wheels, each having a different width and/or diameter to the rear wheels, connected via a replacement axle. As such, the rear wheels may be replaced for replacement wheels that are larger, smaller, more lightweight, more stable or otherwise preferably for a particular scenario or infant. The rear wheel set may comprise a brake system operable to selectively prevent rotation of at least one rear wheel of the rear wheel set. The brake system may comprise a brake pedal positioned on or adjacent to the axle and actuable by a user's foot.

The child transportation system may further comprise a basket configurable in a narrow orientation, wherein the basket has a first width, and a wide orientation, wherein the basket has a second width greater than the first width. In this way, the basket may be configurable according to the configuration of the frame. The basket may be configurable in other orientations such with a lesser width than the narrow orientation, a width between the narrow and wide orientations, or with a greater width than the wide orientation. The basket may comprise a zip or other fastener operable to gather excess material when the basket is configured in the narrow orientation.

### EXAMPLE EMBODIMENTS

Example 1: A child transportation system comprising: a child car seat system comprising: a docking module configured to be securable to a vehicle seat; and an infant carrier module configured to receive an infant therein and arranged to be releasably docked with the docking module, the infant carrier module comprising a seat portion attached to a backrest portion via a locking hinge having two locking positions such that the infant carrier module is configurable in: an upright position in which the seat portion and the backrest portion are relatively inclined at a first angle; and a lie flat position in which the seat portion and the backrest portion are relatively inclined at a second angle, greater than the first angle; wherein the system is configured such that the infant carrier module is adjustable within the docking module; and a wheeled frame releasably attachable to the infant carrier module; wherein, in use with the infant carrier module attached to the wheeled frame, the infant carrier module is configurable in the upright position to form a first pram arrangement and in the lie flat position to form a second pram arrangement.

Example 2: A child transportation system comprising: an infant carrier module configured to receive an infant therein and arranged, the infant carrier module comprising a seat portion attached to a backrest portion via a locking hinge having two locking positions such that the infant carrier module is configurable in: an upright position in which the seat portion and the backrest portion are relatively inclined at a first angle; and a lie flat position in which the seat portion and the backrest portion are relatively inclined at a second angle, greater than the first angle; and a wheeled frame releasably attachable to the infant carrier module; wherein, in use with the infant carrier module attached to the wheeled frame, the infant carrier module is configurable in the upright position to form a first pram arrangement and in the lie flat position to form a second pram arrangement.

Example 3: The child transportation system of Example 1 or Example 2, wherein the wheeled frame includes two frame portions attached via two frame hinges, wherein the infant carrier module is attachable to the wheeled frame such that a first side of the infant carrier module is adjacent to a first of the two frame hinges and a second side of the infant carrier module, opposite the first side, is adjacent to a second of the two frame hinges; preferably wherein the seat attached to the wheeled frame includes a bumper bar attached, at a first end thereof, to a first side of the wheeled frame and is attached, at a second end thereof, to a second side of the wheeled frame, further wherein the infant carrier module is configured to be attachable to the wheeled frame via a bumper bar connection such that the infant carrier module is configured to be attachable to the wheeled frame adjacent to the first and second ends of the bumper bar.

Example 4: The child transportation system of Example 3, wherein the infant carrier module includes a first socket on the first side thereof and a second socket on the second side thereof, and the wheeled frame includes a first protrusion adjacent to the first frame hinge and a second protrusion adjacent to the second frame hinge, further wherein the sockets are configured to receive the protrusions therein to attach the infant carrier module to the wheeled base.

Example 5: The child transportation system of any of Examples 1 to 4, wherein the wheeled frame includes telescopic frame members configurable to arrange the wheeled frame between two frame arrangements having different widths.

Example 6: The child transportation system of Example 5, wherein the telescopic frame members are locked, such that relative movement is restricted, and unlocked, such that relative movement is possible, by rotating a collar into which the frame members may move to reduce the width of the wheeled frame.

### BRIEF DESCRIPTION OF THE DRAWINGS

The disclosure will be further described in embodiments identified in the accompanying figures in which:

FIG. 1 is perspective view of an adjustable pram frame;

FIG. 2 is a perspective sectional view of a handle actuator of the pram frame of FIG. 1;

FIG. 3 is a cross-sectional view of the handle actuator of FIG. 2;

FIG. 4 is a cross-sectional view of a handle adjustment mechanism of the pram frame of FIG. 1;

FIG. 5 is a perspective view of the handle of the pram frame of FIG. 1 in an extended configuration;

FIG. 6 is a perspective view of the handle of the pram frame of FIG. 1 in a collapsed arrangement;

FIG. 7 is a cross-sectional view of a handle joint of the pram frame of FIG. 1;

FIG. 8 is a perspective view of the pram frame of FIG. 1 in a folded configuration;

FIG. 9 is a cross-sectional view of a width adjustment mechanism of the handle of FIGS. 5 and 6;

FIG. 10 is an exploded view of a side joint mechanism of the pram frame of FIG. 1;

FIG. 11 is a schematic side view of the side joint mechanism of FIG. 10 in an extended configuration;

FIG. 12 is a schematic side view of the side joint mechanism of FIG. 10 in a folded configuration;

FIG. 13 is a perspective view of the pram frame of FIG. 1 with a seat structure;

FIG. 14 is a perspective view of the pram frame and seat structure of FIG. 13 in a folded configuration;

FIG. 15 is an exploded view of a backrest angle adjustment mechanism of the seat of FIG. 13;

FIG. 16 is a cross-sectional view of a bumper bar joint mechanism of the seat structure of FIG. 13;

FIG. 17 is an exploded view of a seat detachment mechanism of the seat structure of FIG. 13;

FIG. 18 is a perspective view of the pram frame of FIG. 1 with the rear wheels and axle detached;

FIG. 19 is a cross-sectional view of a rear leg cross bar width adjustment mechanism;

FIG. 20 is a perspective view of a front leg cross bar width adjustment mechanism;

FIG. 21 is an exploded view of a front wheel of the pram frame of FIG. 1;

FIG. 22 is an exploded view of a rear wheel of the pram frame of FIG. 1;

FIG. 23 is a perspective view of the pram frame of FIG. 1 with an infant carrier module attached thereto;

FIG. 24 is an exploded view of the pram frame with a seat structure of FIG. 13;

FIG. 25 is a perspective view of an attachment adapter;

FIG. 26 is an exploded view of the pram frame with an infant carrier module of FIG. 23;

FIG. 27 is a rear perspective view of the pram frame with a seat structure of FIG. 13;

FIG. 28 is a first cross-sectional view of a memory lock mechanism;

FIG. 29 is a second cross-sectional view of the memory lock mechanism of FIG. 28;

FIG. 30 is a perspective view of the backrest unlock handle shown in FIG. 13 in a first arrangement;

FIG. 31 is a perspective view of the backrest unlock handle shown in FIG. 13 in a second arrangement;

FIG. 32 is a perspective view of the backrest unlock handle shown in FIG. 13 in a third arrangement;

FIG. 33 is a perspective view of the seat structure shown in FIG. 13 with the backrest and bumper bar in a first orientation;

FIG. 34 is a perspective view of the seat structure shown in FIG. 13 with the backrest and bumper bar in a second orientation; and

FIG. 35 is a perspective view of the seat structure shown in FIG. 13 in a collapsed orientation.

### DETAILED DESCRIPTION

The following description presents exemplary embodiments and, together with the drawings, serves to explain principles of the disclosure. However, the scope of the invention is not intended to be limited to the precise details of the embodiments, since variations will be apparent to a skilled person and are deemed also to be covered by the description. Terms for components used herein should be given a broad interpretation that also encompasses equivalent functions and features. In some cases, alternative terms for structural features may be provided but such terms are not intended to be exhaustive.

Descriptive terms should also be given the broadest possible interpretation; e.g. the term “comprising” as used in this specification means “consisting at least in part of” such that interpreting each statement in this specification that includes the term “comprising”, features other than that or those prefaced by the term may also be present. Related terms such as “comprise” and “comprises” are to be interpreted in the same manner. Directional terms such as “vertical”, “horizontal”, “up”, “down”, “top”, “bottom”, “upper” and “lower” are used for convenience of explanation usually with reference to the illustrations and are not intended to be ultimately limiting if an equivalent function can be achieved with an alternative dimension, orientation and/or direction.

The description herein refers to embodiments with particular combinations of features, however, it is envisaged that further combinations and cross-combinations of compatible features between embodiments will be possible. Indeed, isolated features may function independently as an invention from other features and not necessarily require implementation as a complete combination.

The general descriptive terms “child car seat” and “pram” related to the field of the disclosure are also not intended to be limiting. In the present field there are a wide range of terms applicable to the present disclosure and can be used interchangeably to describe the device, without affecting its scope and interpretation. For example, a “child car seat” can be a catch-all term for a safety device used by a baby, toddler or child for both sitting, reclining and/or laying down in a flat position, e.g. a booster seat or carrier respectively. The term “pram” used herein if intended to be a reference to a perambulator, buggy, pushchair, stroller, umbrella folding stroller or carriage.

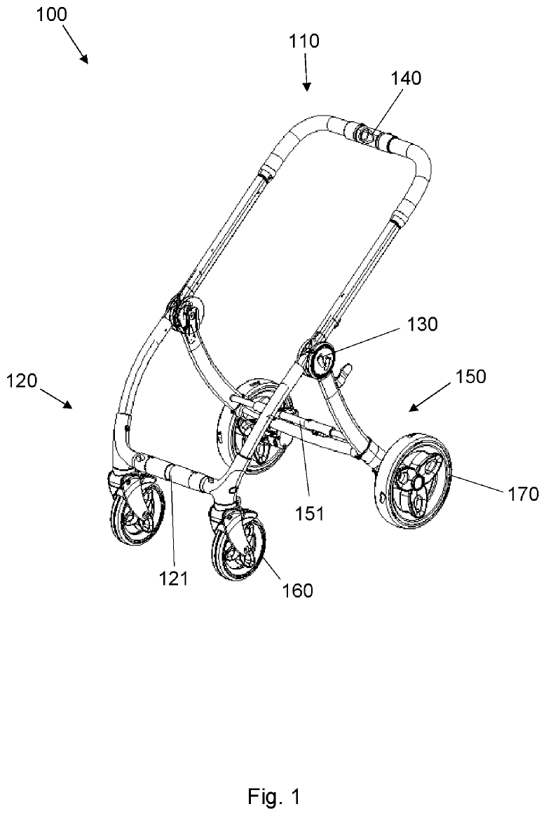

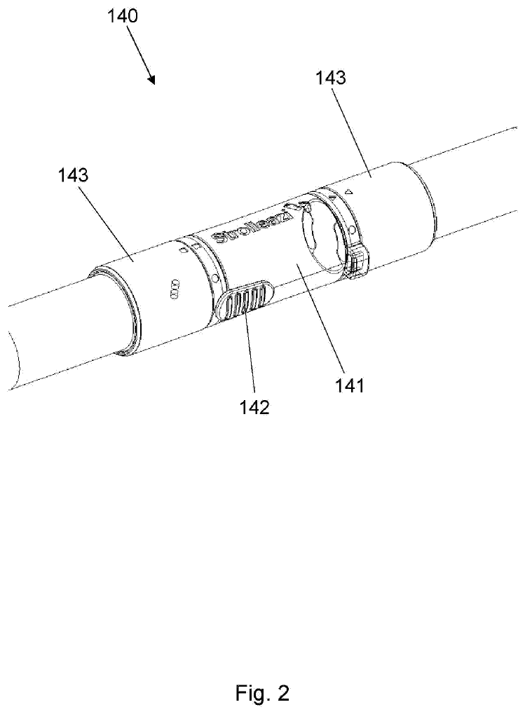

FIG. 1 is perspective view of an adjustable pram frame 100. The frame 100 includes a telescopic handle section 110 attached to a front wheel section 120 via side locking hinges 130. A portion of the handle section 110 may be moved telescopically into or out of another portion to reduce or increase a height of the handle section 110. The handle section 110 includes a proximal end intended to be held by a user when pushing or pulling the pram frame 100. The proximal end of the handle section 110 includes a locking and unlocking handle actuator 140. The handle actuator 140 may be used to lock or unlock the telescopic function of the handle section 110, in particular by sliding or rotating a portion of the handle actuator 140 and is discussed in more detail with reference to FIGS. 2 to 4.

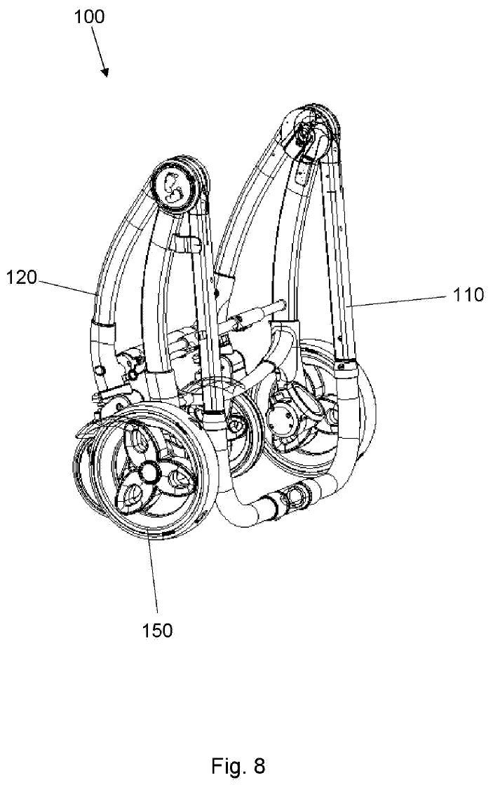

The frame 100 also includes a rear wheel section 150 attached to the handle section 110 and the front wheel section 120 via the locking hinges 130. The locking hinges 130 may therefore be three way hinges. The frame 100 may be arranged in a pram configuration, as shown in FIG. 1, wherein the handle portion 110 and the front wheel portion 120 are substantially linear and the rear wheel section 150 extends away from the handle section 110 and the front wheel section 120 to form a generally ‘T’ shaped frame. Alternatively, the hinges 130 may be released and the frame 100 may be arranged in a collapsed arrangement, as discussed in more detail with reference to FIG. 8.

The front wheel section 120 includes a front cross member 121, and the rear wheel section 150 includes a rear cross member 151. Each of the cross members 121, 151, shown as the lower horizontal members in FIG. 1, of the frame 100 are telescopic such that they are adjustable in length to adjust a width of the frame 100 between a relatively wide comfort arrangement and a relatively narrow compact arrangement. The locking actuator 140 may be actuated in a third manner to release a width locking of the frame 100 to allow for the width of the wheeled frame 100 to be adjusted, as discussed with reference to FIG. 2.

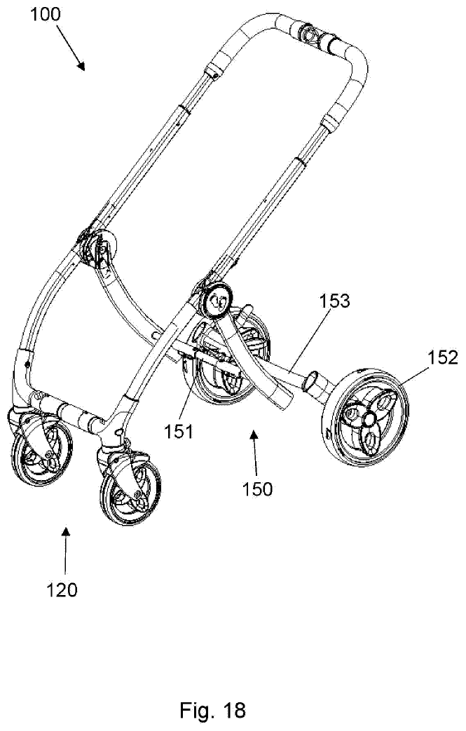

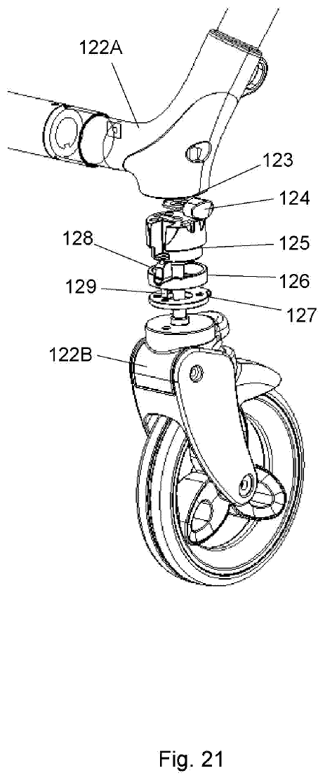

The front wheel section 120 includes front wheels 160 and the rear wheel section 150 includes rear wheels 170. The front wheels 160 and the rear wheels 170 are releasably attached such that they are replaceable, as discussed with reference to FIGS. 18 and 21.

FIG. 2 is a perspective sectional view of a handle actuator 140 of the pram frame of FIG. 1. The handle actuator 140 includes a central actuator 141, a lock slide 142 and two peripheral actuators 143 positioned at each end of the central actuator 141.

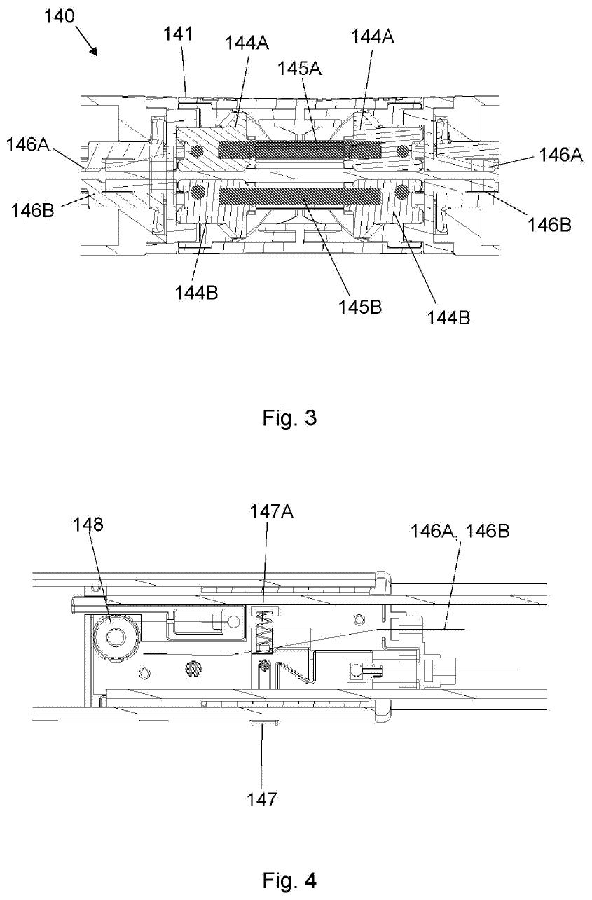

To release the telescopic height adjustment of the handle section 110, a user may rotate the central actuator 141 forward by approximately 60°. Other angles and backwards rotation are also envisaged. The unlocking of the locking mechanism is discussed with reference to FIGS. 3 and 4. After the central actuator 141 has been rotated forwards, the handle section 110 may be pushed or pulled to telescopically decrease or increase the height of the handle section 110. Once the handle section 110 has been arranged at the preferred height, the central actuator 141 may be rotated back to the original starting position to lock the height adjustment of the handle section 141.

The handle section 110 may also be folded or hinged about the side locking hinges 130 when the frame 100 is collapsed. To release the handle fold mechanism, a user may rotate the central actuator 141 beyond approximately 60° such as to approximately 120 °. The lock slide 142 is provided to selectively prevent the central actuator 141 being rotated beyond approximately 60°. Therefore, a user may actuate and hold the lock slide 142 whilst rotating the central actuator 141 beyond approximately 60°. The unlocking of the locking mechanism is discussed with reference to FIGS. 3, 4 and 7. Once the locking mechanism has been unlocked via rotation of the central actuator 141, a user may fold or hinge the handle section about the side locking hinges 130. The handle section 110 may only be folded or hinged about the side locking hinges 130 when arranged in a lowermost or shortest arrangement, as shown in FIG. 6.

A user may adjust the width of the frame 100 by lengthening or shortening the telescopic handle portion 110, front cross member 121 and rear cross member 151. The rear wheels 170 and axle may also be replaced, as discussed with reference to FIG. 18. To unlock the width locking mechanism, a user may rotate the peripheral actuators 143, such as by approximately 60° or any other desirable angle. The user may then push or pull the telescopic handle members to adjust the width of the handle portion 110. Once the preferred width has been set, the user may then return the peripheral actuators 143 to the original position to engage the width locking mechanism.

FIG. 3 is a cross-sectional view of the handle actuator 140 of FIG. 2 in a rest position. The handle actuator 140 includes a central actuator 141, upper cable connect sliders 144A, lower cable connect sliders 144B, upper spring 145A, lower spring 145B, handle height latch wires 146A and handle fold wires 146B.

To unlock the handle height latch such that the height of the handle is adjustable, a user may rotate the central actuator 141 which in turn pushes the upper cable connect sliders 144A towards each other, compressing the upper spring 145A. The movement of the upper cable sliders 144A pulls the handle height latch wires 146A, which in turn pull latch pins out of their housing to allow the height of the handle to be adjusted. Moving the central actuator 141 back to the original position allows the upper spring 145A to move the upper cable sliders 144A apart and release the handle height latch wires 146A.

To unlock the handle fold latch such that the handle may be folded, a user may rotate the peripheral actuators, which in turn pushes the lower cable connect sliders 144B towards each other, compressing the lower spring 145B. The movement of the lower cable sliders 144B pulls the handle fold latch wires 146B, which in turn pull latch pins out of their housing to allow the handle to fold. Moving the peripheral actuators back to their original position allows the lower spring 145B to move the lower cable sliders 144B apart and release the handle fold latch wires 146B.

FIG. 4 is a cross-sectional view of a handle adjustment mechanism of the pram frame 100 of FIG. 1. The adjustment mechanism depicted in FIG. 4 may be used in the handle height adjustment and the handle fold mechanism. The wire 146A, 146B passes through an internal end of a latch pin 147, around a cable wheel 148 and has a fixed end. The wire 146A, 146B passes through the latch pin 147 at an angle such that, when the wire 146A, 146B is pulled, the latch pin 147 is pulled out of an aperture such that the mechanism is unlocked. A spring 147A biases the latch pin 147 into the aperture to lock the mechanism.

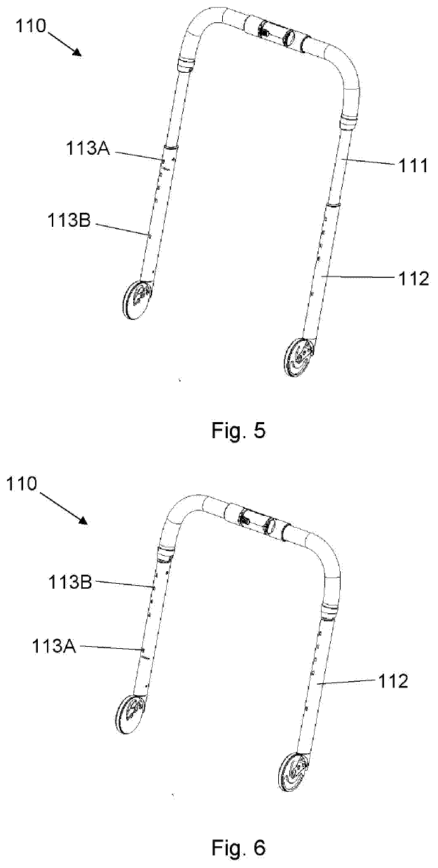

FIGS. 5 and 6 are perspective views of the handle portion 110 of the pram frame of FIG. 1 in an extended configuration and a collapsed configuration respectively. The handle portion 110 includes upper telescopic members 111 and lower telescopic members 112. To adjust the height of the handle portion 110 between a maximum height position, as shown in FIG. 5, and a minimum height position, as shown in FIG. 6, the upper telescopic members 111 are telescopically received within the lower telescopic members 112. The handle portion 110 includes latch pins 113A releasably positionable within one of a plurality of apertures 113B to secure the handle portion at the preferred height. The handle portion 110 may include four or more apertures 113B and therefore be securable in four or more height positions. The actuation of the latch pins 113A is discussed with reference to FIG. 4.

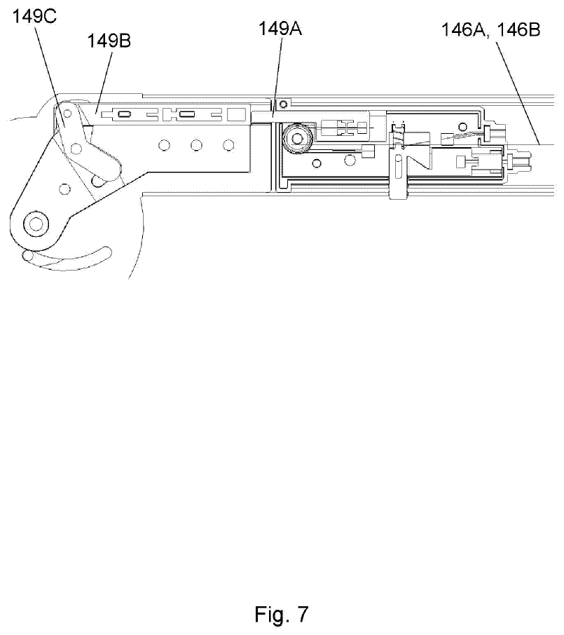

FIG. 7 is a cross-sectional view of a handle joint of the pram frame 100 of FIG. 1. The right half of the Figure is discussed with reference to FIG. 4. Additionally, when the wire 146A, 146B is pulled, a slider 149A is pulled left in the orientation shown in FIG. 4. The slider 149A pushes an unlock lever 149B, which in turn rotates a latch lever 149C to unlock the side joint to fold or collapse the frame 100.

FIG. 8 is a perspective view of the pram frame 100 of FIG. 1 in a folded configuration. When compared to the arrangement shown in FIG. 1, the handle section 110, the front wheel section 120 and the rear wheel section 150 have been rotated about the side hinges 130 such that they are adjacent to each other. As discussed previously, the handle section 110 has also been set to the minimum height setting. The collapsed arrangement may be particularly suitable when transporting the frame 100.

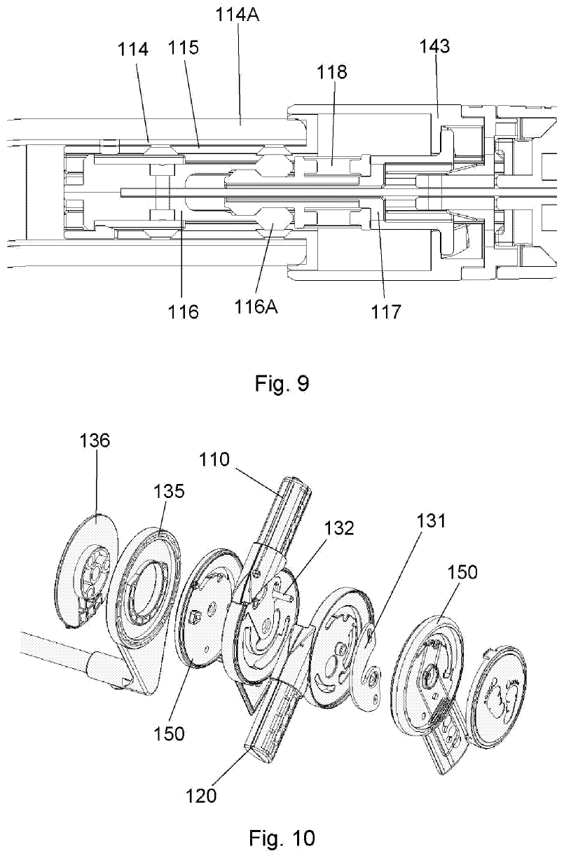

FIG. 9 is a cross-sectional view of a width adjustment mechanism of the handle portion 110 shown in FIGS. 5 and 6. The mechanism includes peripheral actuators 143, as shown in FIG. 2, upper handle tube 114 with a foam cover 114A, a handle width retainer 115, a width fixing latch 116, a flexible locking pin 116A attached to the fixing latch 116, a width lock activator 117 and a spring 118. When the peripheral actuators 143 are rotated to unlock the mechanism, the width lock activator 117 is urged by the spring 118 away from the flexible locking pin 116A such that the flexible locking pin 116A is unlocked and the width may be adjusted. When the preferred width has been set, the peripheral actuators 143 may be rotated back to their original position such that the width lock actuator 117 moves and pushes the fixing latch 116 to engage the locking pin 116A within an aperture in the retainer 115 to lock the width adjustment of the handle.

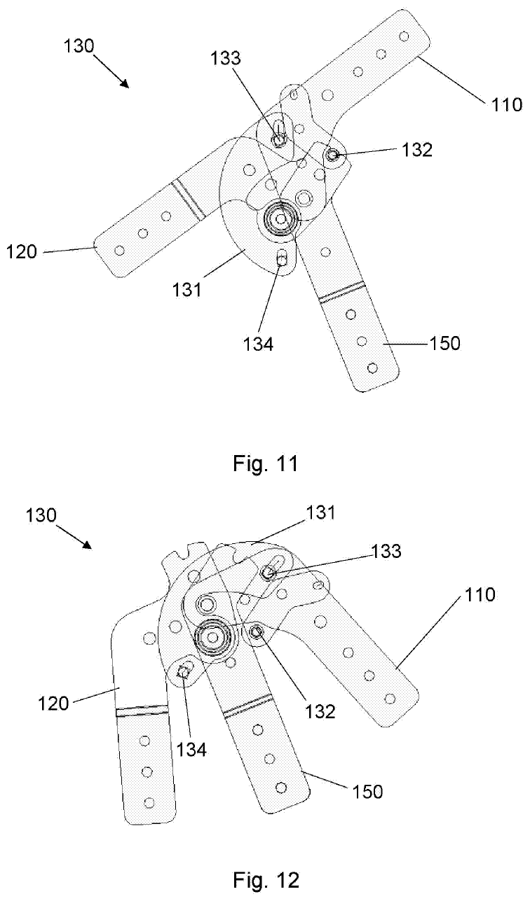

FIG. 10 is an exploded view of a side joint mechanism 130 of the pram frame 100 of FIG. 1, and FIGS. 11 and 12 are schematic side views of the side joint 130 mechanism of FIG. 10 in an extended and folded configuration respectively. The side joints 130 include members belonging to the handle portion 110, the front wheel portion 120 and the rear wheel portion 150. The side joint 130 includes a linkage plate 131, a lock pin 132, a first fixed point 133, a second fixed point 134, a side joint width linked tube hinge 135 and a seat mount 136. The first fixed point 133 is fixed to the handle portion 110. The second fixed point 134 is fixed between inner and outer plates of the rear wheel section 150. When the handle portion 110 is folded down, the first fixed point 133 is driven to rotate, causing the upper end of the linkage plate 131 to rotate clockwise. The linkage plate 131 is fixed to the front leg portion 120. Accordingly, when the linkage plate 131 rotates clockwise, a groove in the lower end groove of the linkage plate 131, which is fixed to the rear wheel portion 150, is driven to rotate. The second fixed point 134 therefore rotates clockwise. In this way, the handle portion 110 rotates clockwise to fold, and the front wheel portion 120 and the rear wheel portion 150 rotate clockwise in equal proportions. As such, a linkage is created between the wheel portions 120, 150.

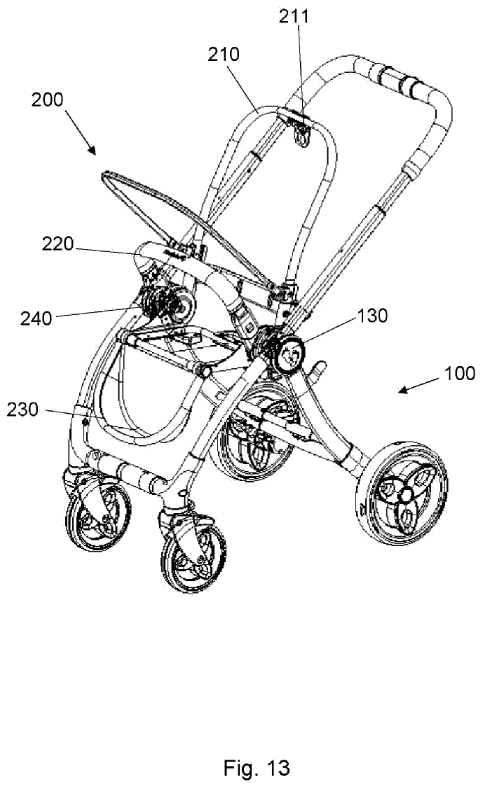

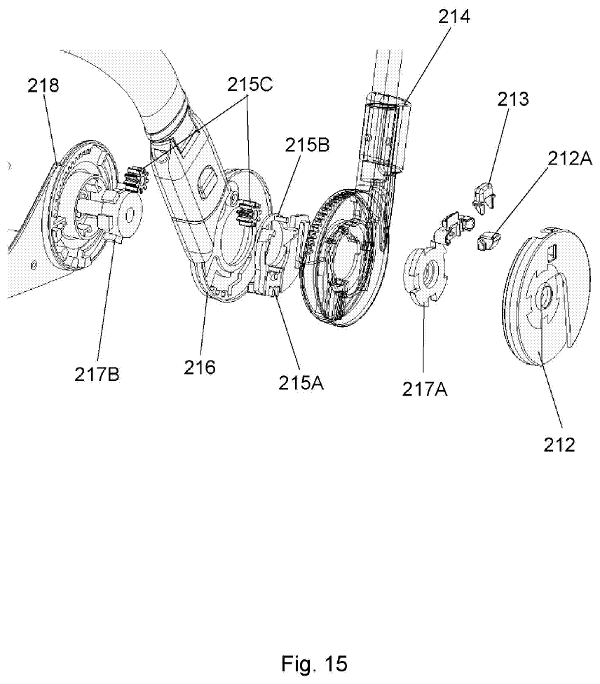

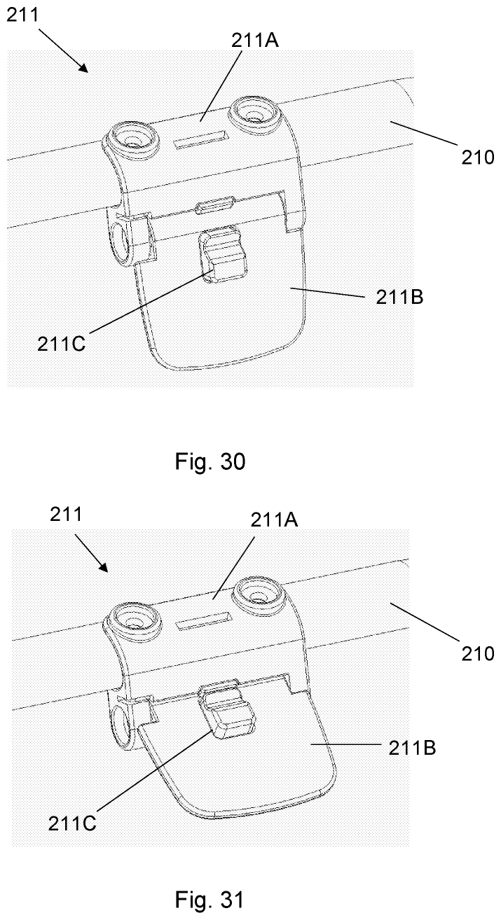

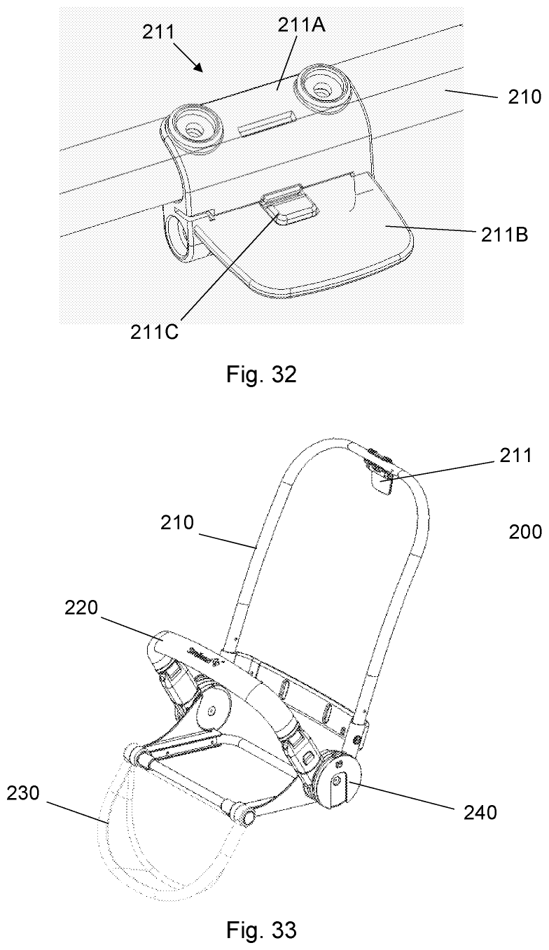

FIG. 13 is a perspective view of the pram frame 100 of FIG. 1 with a seat structure 200 attached to the frame 100. The seat 200 includes a backrest member 210, a bumper bar 220, a footrest 230 and a seat joint 240. The seat 200 is configured to attach to the frame 100 via the seat joint 240 arrangement, which attaches to the frame 100 adjacent to the side joints 130 of the frame 100. The backrest 210 is adjustable in angle about the seat joint 240 and includes a backrest unlock handle 211 which is discussed in more detail with reference to FIGS. 30 to 32. Folding the backrest unlock handle 211 pulls internal wires to unlock the backrest 210, in a similar manner to that described with reference to FIGS. 3 and 4. The backrest unlock handle 211 includes a second lock configured to limit rotation or folding of the backrest unlock handle 211 to approximately 45°, as described in more detail with reference to FIG. 32. The backrest 210 unlock mechanism is described with reference to FIG. 15.

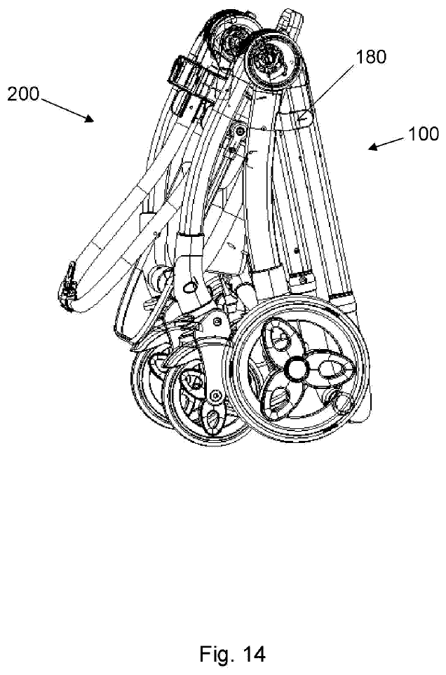

FIG. 14 is a perspective view of the pram frame 100 and seat structure 200 of FIG. 13 in a folded configuration. The folding of the pram frame 100 is as discussed with reference to FIG. 8. Prior to the frame 100 being folded, each member of the seat structure 200 is folded down forwards or rearwards such that they lie adjacent to the front or rear wheel section respectively. As such, the seat structure 200 and frame may fold down into a position preferable for travel or storage. The frame 100 includes an auto lock member 180 attached to the rear wheel portion and configured to snap over and retain the handle portion next to the rear wheel portion such that the frame 100 is held in the collapsed arrangement.

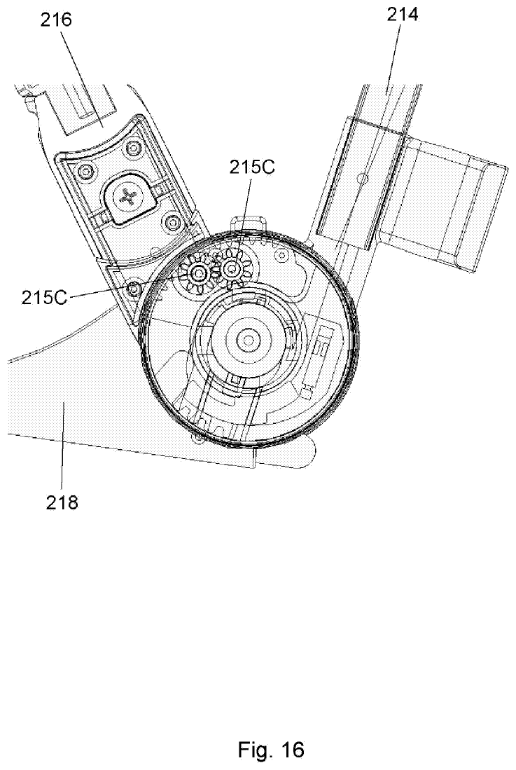

FIG. 15 is an exploded view of a backrest 210 angle adjustment mechanism of the seat 200 of FIG. 13 and FIG. 16 is a cross-sectional view of a bumper bar joint mechanism of the seat structure 200 of FIG. 13. The mechanism includes the seat attachment joint 212, a seat unlock button 212A, a seat latch 213, a backrest joint 214, a backrest adjustment drive gear 215A, a backrest adjustment push gear 215B, a seat linked gear 215C, a bumper bar support joint 216, a seat lock gear 217A, a backrest lock gear 217B and a seat joint inner 218. An internal surface of the backrest joint 214 includes gear teeth arranged to interlock and engage with one or more gears of the seat linked gear 215C, shown as the left gear in FIG. 16. The right gear in FIG. 16 is arranged to move the bumper bar 216 when rotated. The left and right seat linked gears 215C are equal in size and number of teeth. Accordingly, a 1:1 ratio is provided between the two seat linked gears 215C. Accordingly, a rotation applied by a user to the backrest 210 or the bumper bar 220 will also be equally applied to the other of the backrest 210 and the bumper bar 220 via the seat linked gears 215C. For example, if a user were to rotate the backrest 210, represented by backrest joint portion 214, clockwise 10° from the orientation shown in FIG. 16, the teeth on the backrest 210 housing will be rotated by 10°. The teeth on the backrest 210 housing will engage and rotate the left gear 215C which will in turn apply an equal rotation to the right gear 215C, causing the bumper bar to be rotated clockwise by 10°, matching the rotation of the backrest 210.

When the backrest unlock handle 211 is folded, the internal wire is pulled which in turn pulls the backrest adjustment drive gear 215A to actuate it. This moves the backrest adjustment drive gear 215A out of the slots in the bumper bar support joint 216 and the seat joint inner 218 to allow for the backrest to be adjusted. When the backrest joint 214 is folded forwards or backwards, the seat linked gears 215C drive the bumper bar support joint 216 such that the bumper bar is moved forwards and backwards by an angle equal to that of the backrest bar. Accordingly, the bumper bar will follow the backrest bar as the backrest bar is adjusted.

FIG. 15 also shows the seat joint folding mechanism. When the seat is to be folded, the backrest adjustment drive gear 215A pushes the backrest adjustment push gear 215B to the left, in the orientation shown in FIG. 15, under the action of the inclined plane. Furthermore, the backrest adjustment push gear 215B pushes the seat lock gear 217A and the backrest lock gear 217B. Accordingly, the seat lock gear 217A and the backrest lock gear 217B disengage from locking teeth on the rear surface of the seat attachment joint 212, such that the seat attachment joint 212 is unlocked and can rotate freely.

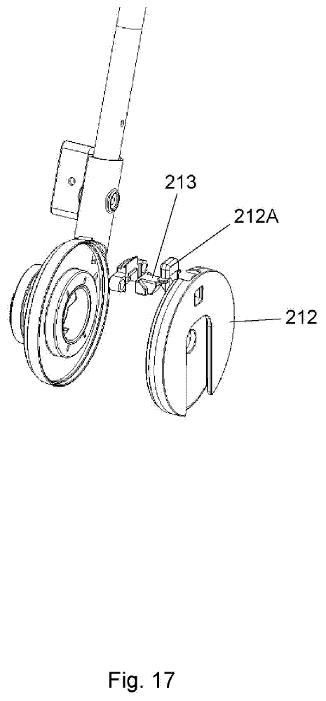

FIG. 17 is an exploded view of a seat detachment mechanism of the seat structure 200 of FIG. 13. To remove the seat from the frame, a user may press down the seat unlock latch 212A and push the latch 213 to unlock the seat so that the user may then lift and remove the seat from the frame.

FIG. 18 is a perspective view of the pram frame 100 of FIG. 1 with the rear wheels 152 and rear axle 153 detached. The rear wheels 152 are removed as a pair along with the connecting axle 153. A relatively large set of rear wheels 152 are shown in FIG. 18. The rear wheel section 150 separates between the rear wheels 152 and the telescopic cross member 151. In this way, the cross member 151 may provide stability to the rear wheel section 150 whilst the rear wheels 152 are changed. The rear wheels 152 and axle 153 may be removed and the rear cross member 151 telescopically shortened or lengthened whilst adjusting the width of the frame 100. Relatively large wheels 152 may provide a more comfortable ride than relatively smaller wheels. Relatively smaller replacement wheels may be provided, such as a set of wheels equivalent in size to the wheels of the front wheel section 120.

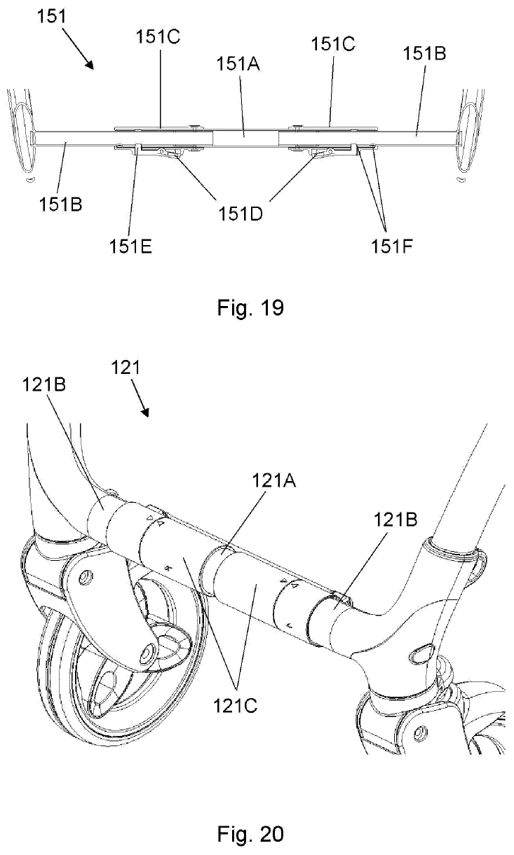

FIG. 19 is a cross-sectional view of the rear leg cross member 151 width adjustment mechanism. The cross member 151 includes a central tube 151A that is telescopically received within two outer tubes 151B, or vice versa. Two tube retainers 151C are provided between the central tube 151A and the outer tubes 151B. The tube retainers 151C include latch buttons 151D operable to remove a latch pin 151E from locking holes 151F. At least two locking holes 151F are provided and receive the latch pins 151E to secure the cross member 151 in one of at least two width arrangements.

FIG. 20 is a perspective view of a front leg cross member 121 width adjustment mechanism. The cross member 121 includes a central tube 121A that is telescopically received within two outer tubes 121B, or vice versa. The cross member 121 also includes two unlock knobs 121C rotatable by a user to unlock the locking mechanism, such that the user may push or pull the cross member 121 to a different length, before rotating the unlock knobs 121C back into their original positions to lock the cross member 121 at the desired length.

FIG. 21 is an exploded view of a front wheel of the pram frame 100 of FIG. 1. Each front wheel arrangement includes a front leg upper housing 122A, a front wheel lower housing 122B, a front wheel lock plate 123, a front wheel detachable button 124, a front wheel housing insert 125, a front wheel direction locker 126, a front wheel housing bottom cover 127, a front wheel direction lock base 128 and a front wheel direction lock pin 129. A user may press the front wheel direction lock 126 to drive the front wheel direction lock base 128 and the front wheel direction lock pin 129, so that the lock pin 129 can move up and down and fall into a front positioning hole of the front wheel lower housing 122B and lock the front wheel in a forward facing arrangement. To remove the front wheel, a user may press the front wheel detachable button 124 and let the wheel lock plate 123 exit a groove in a central post of the front wheel lower housing 122B, such that the front wheel may be removed. The front wheel may be provided with a suspension system as described herein.

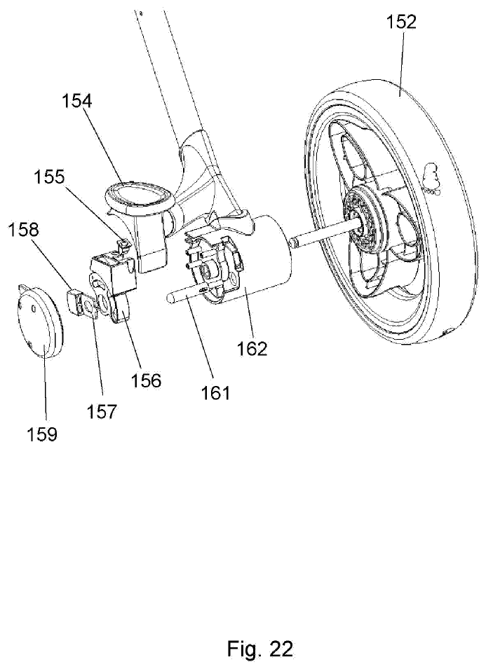

FIG. 22 is an exploded view of a rear wheel of the pram frame 100 of FIG. 1. The rear wheel arrangement includes a rear wheel 152, a brake paddle 154, a brake paddle stopper 155, a brake drive gear 156, a rear wheel lock plate 157, a rear wheel detach button 158, a rear wheel housing cover 159, a brake pin 161 and a rear wheel housing 162. The brake paddle 154, the brake paddle stopper 155 and the brake drive gear 156 are provided in combination. When the brake paddle 154 is turned to abut the brake paddle stopper 155, the rotation of the lock plate 157 drives the housing 162 to move to the right, in the orientation shown, and fall into a brake tooth of the wheel 152 and prevent rotation of the wheel 152. The other rear wheel (not shown) may include a drive gear and housing arranged to be actuated and lockable via the brake paddle 154. An internal wire is provided to link the two housings 162 such that the left wheel brake is engaged when the right wheel brake is engaged. The arrangement shown in FIG. 22 may be the comfort rear wheel group. The compact rear wheel group may have the same, or different, braking mechanism.

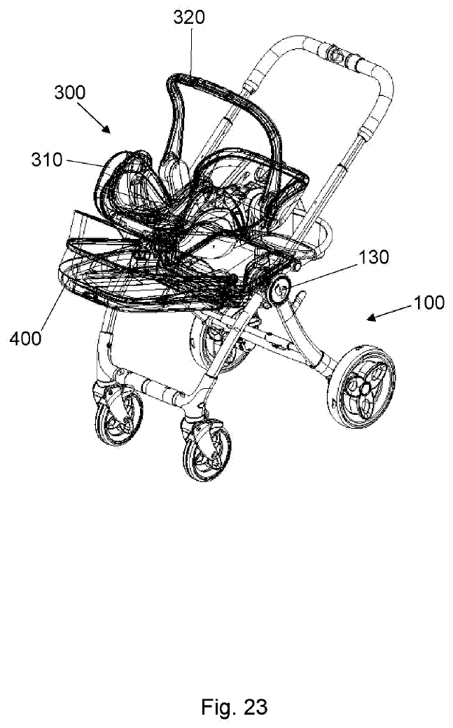

FIG. 23 is a perspective view of the pram frame 100 of FIG. 1 with an infant carrier module 300 attached thereto. The infant carrier module 300 is suitable for carrying an infant and may be, for example, a car seat structure. The infant carrier module 300 includes a shell portion 310 providing a seat structure, and a carrier handle 320 attached to the shell portion. The infant carrier module 300 may attach to the frame 100 at points adjacent to the attachment points of the carrier handle 320 of the infant carrier module 300, for stability. The infant carrier module 300 may attach to the wheeled frame 100 between the locking side hinges 130, without the need for additional adapters. The infant carrier module 300 may attach to the seat 200 via the bumper bar 220 attachment housing. Accordingly, the infant carrier module 300 may be attached to the frame 100 via the seat 200, as discussed herein. The angle at which the infant carrier module 300 is supported by the frame 100 may be adjustable. An adjustable canopy 400 is also provided.

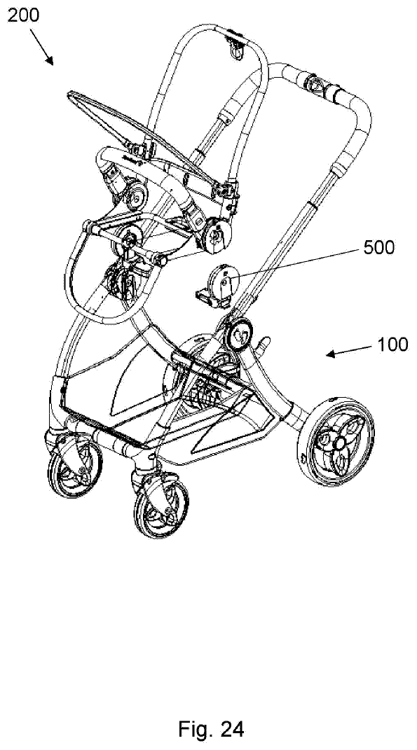

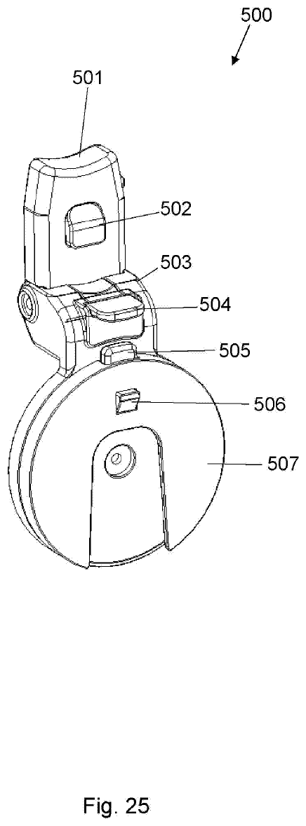

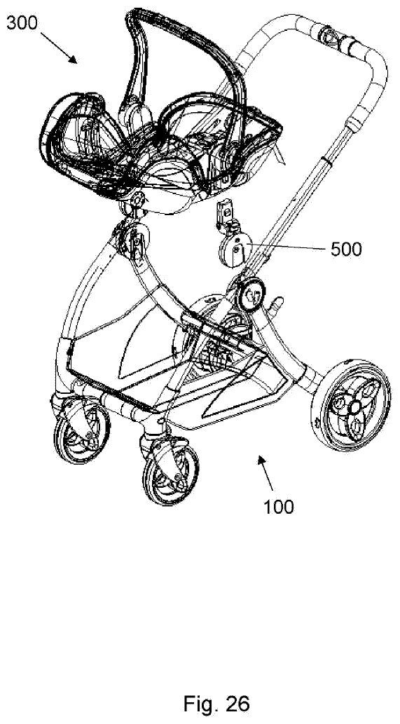

FIG. 24 is an exploded view of the pram frame 100 with the seat structure 200 of FIG. 13. The frame 100 is arranged in the relatively wide comfort arrangement. As such, the frame 100 may be too wide to accept the seat 200 directly thereon. Accordingly, the system may comprise adapters 500, discussed with reference to FIG. 25. The adapters 500 connect at one end to the frame 100 and at the other end to the seat 200, to bridge the gap between the seat 200 and the frame 100. FIG. 25 is a perspective view of an attachment adapter 500. The adapter 500 includes an infant carrier male docking member 501, a lock button 502, a swivel joint 503, a swivel latch 504, a detach button 505, a latch 506 and an attachment joint 507. The adapter 500 is configurable in three arrangements. The first arrangement shown in FIG. 25, a second arrangement in which the male docking member 501 is folded over forwards 90°about the swivel joint 503, and a third arrangement similar to the second arrangement save for the attachment joint 507 being rotated through 180°. In FIG. 24, the adapter 500 is shown in the third arrangement and may be used to attach the seat 200 to the frame 100. FIG. 26 is an exploded view of the pram frame 100 with the infant carrier module 300 of FIG. 23. The seat 200 and the canopy 400 are not shown, for clarity. The adapter 500 is shown in the first configuration and may be used to attach the infant carrier module 300 to the frame 100.

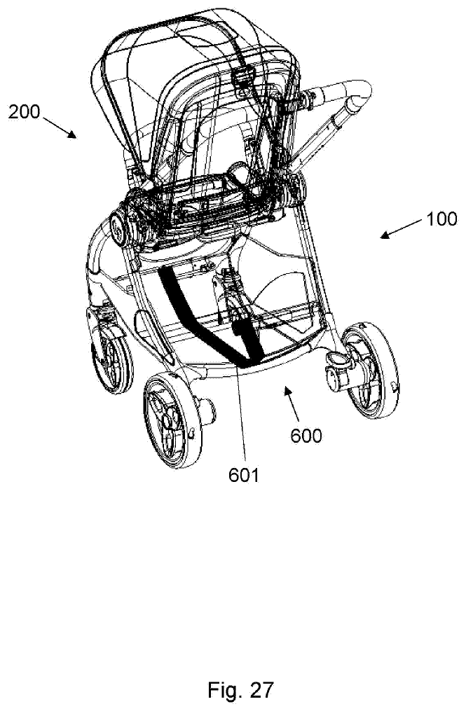

FIG. 27 is a rear perspective view of the pram frame 100 with the seat structure 200 of FIG. 13. The frame 100 includes a basket 600 attached below the seat structure 200. The basket 600 includes a zip 601 releasable to increase the width of the basket 600. The zip 601 gathers excess material when the frame 100 is arranged in the relative narrow compact arrangement, and the excess material is used to widen the basket 600 when the frame 100 is arranged in the relatively wide comfort arrangement.

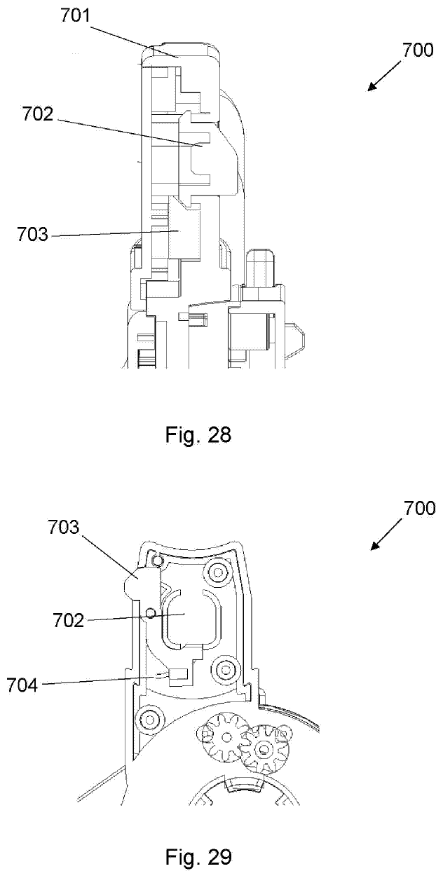

FIGS. 28 and 29 are first and second cross-sectional views of a memory lock mechanism 700 respectively. The memory lock mechanism 700 includes a bumper bar male portion 701, a memory lock button 702, a memory lock stopper 703, a spring 704 and an infant carrier docking female portion (not shown). A user may press the memory lock button 702 which may cause the memory lock stopper 703 to rotate under the action of the inclined plane until the memory lock stopper 703 falls into the card slot and the memory lock button 702 is locked inside the bumper bar male portion 701. When the infant carrier docking female portion is removed, the memory lock stopper 703 rotates until the memory lock button 702 comes out of the memory lock stopper 703 card slot, unlocking the memory lock button 702. The memory lock may be provided on each side of the frame 100. As such, to remove a seat or infant carrier module, a user may press the memory lock button on one side of the frame 100, use one hand to hold the seat or infant carrier module and use the other hand to unlock the other memory lock button before lifting the seat or infant carrier module from the frame. The memory lock mechanism 700 may be time dependent such that, should the second memory lock button not be actuated within a predetermined time of the first memory lock button 702 being actuated, the first memory lock may be relocked to secure the infant carrier module. Accordingly, accidental or unintentional actuation of a single memory lock button 702 may be corrected or rectified automatically.

FIGS. 30, 31 and 32 are perspective views of the backrest unlock handle 211 shown in FIG. 13 in first, second and third arrangements respectively. The backrest unlock handle 211 includes a clamp portion 211A attached to the backrest 210. The clamp portion 211A covers an opening in the backrest 210 tube through which the wires or associated components pass to allow the backrest adjustment handle 211 to release the locking mechanism and allow the backrest to recline, as discussed herein.

The backrest unlock handle 211 includes a paddle 211B extending away from the clamp section 211A which may be rotated about the clamp section 211A, as shown in FIGS. 30 and 31, to unlock the mechanism. Furthermore, the backrest unlock handle 211 includes a second lock 211C positioned on the paddle 211B. When the paddle 211B is rotated from the position shown in FIG. 30 to the position shown in FIG. 31, to pull the internal wires and unlock the adjustment of the backrest 210, the second lock 211C abuts the clamp section 211A, as shown in FIG. 31, and prevents further rotation of the paddle 211B.

Rotation of the backrest unlock handle 211 through approximately 45° from the position shown in FIG. 30 into the position shown in FIG. 31 allows linked adjustment of the backrest 210 and the bumper bar 220 such that the angle between the backrest 210 and the bumper bar 220 is maintained. As such, the associated gears remain engaged.

The second lock 211C may be pressed by a user such that the paddle 211B may be rotated further, beyond the position shown in FIG. 31, into the position shown in FIG. 32. Rotating the paddle 211B into the position shown in FIG. 32 pulls the wires further to disengage the gears linking the backrest 210 and the bumper bar 220. Rotation of the backrest unlock handle 211 through approximately 90° from the position shown in FIG. 30 into the position shown in FIG. 32 therefore allows adjustment of the backrest 210 independently of the bumper bar 220 such that the angle between the backrest 210 and the bumper bar 220 is adjustable. As such, the associated gears are disengaged.

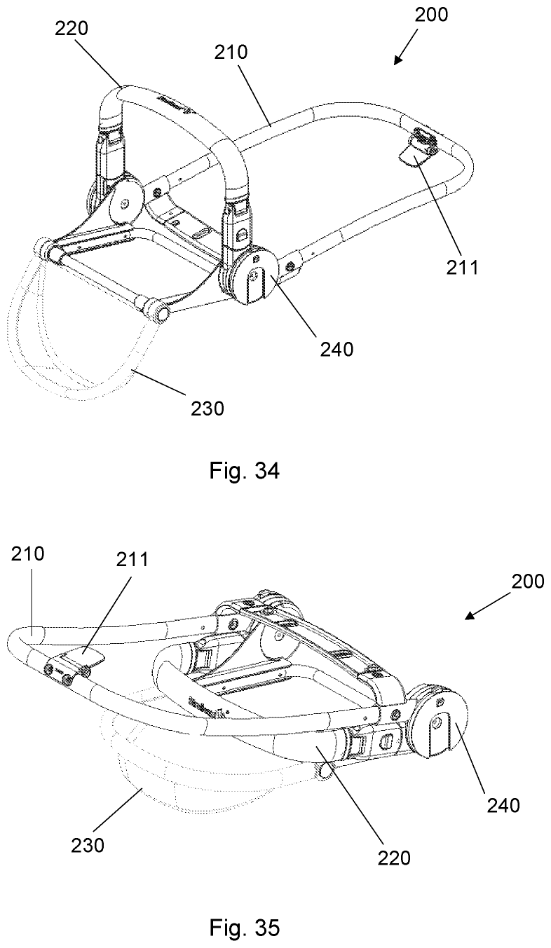

FIGS. 33 and 34 are perspective views of the seat structure 200 shown in FIG. 13 with the backrest 210 and bumper bar 220 in first and second orientations respectively. As discussed with reference to FIGS. 30 and 31 the backrest unlock handle 211 may be moved into the position shown in FIG. 31 to allow linked adjustment of the backrest 210 and the bumper bar 220. The seat 200 may be arranged in various positions, including those shown in FIGS. 33 and 34 and additional positions, such as between those shown in

FIGS. 33, 34 and 35. The arrangement shown in FIG. 33 is a relatively upright arrangement, and the seat 200 in this arrangement may allow an infant to sit upright. The arrangement shown in FIG. 34 is a relatively flat arrangement, and the seat 200 in this arrangement may allow an infant to recline. The foot rest 230 remains stationary whilst the bumper bar 220 and the backrest 210 are moved.

FIG. 35 is a perspective view of the seat structure 200 shown in FIG. 13 in a collapsed orientation. The backrest 210, bumper bar 220 and foot rest 230 have been rotated about the seat joint 240 such that they lie adjacent to each other. In this arrangement, the seat 200 has a relatively small volume and may be more easily stored or transported, when not in use.

1. A child transportation system comprising a frame, wherein the frame comprises: a first frame member telescopically attached to a second frame member; a rear wheel set and a front wheel set; and
an infant carrier attachment mechanism configured and arranged to permit, in use, an infant carrier module to be releasably attached to the frame; wherein the first frame member is telescopically moveable relative to the second frame member to adjust a width of the frame between a compact arrangement, in which the frame has a first width, and a comfort arrangement, in which the frame has a second width greater than the first width.

2. The child transportation system of claim 1, wherein the frame comprises a handle including a first handle portion attached to the first and second frame members and a second handle portion telescopically attached to the first handle portion such that the handle is height adjustable.

3. The child transportation system of claim 2, wherein the second handle portion is releasably securable relative to the first handle portion at a plurality of positions via a handle lock.

4. The child transportation system of claim 3, wherein the second handle portion further comprises a handle release actuator operable to selectively release and engage the handle lock.

5. The child transportation system of claim 4, wherein the handle release actuator comprises a rotatable handle portion rotatable between a locking position, in which the handle lock prevents height adjustment of the handle, and a height release position, in which the handle lock is disengaged and the handle is height adjustable.

6. The child transportation system of claim 5, wherein the handle lock comprises at least one latch pin configured to engage with the first and second handle portions to prevent relative movement of the first and second handle portions when the release actuator is arranged in the lock position, further wherein rotation of the rotatable handle portion from the lock position to the release position pulls the at least one latch pin, via a connection member, away from the first or second handle portion such that relative movement of the first and second handle portions is possible.

7. The child transportation system of claim 2, wherein the first handle portion is attached to the first and second frame members via a handle hinge, wherein the handle hinge is configurable in a first orientation, in which the handle is extended, and a second orientation, in which the handle is folded.

8. The child transportation system of claim 7, wherein the handle hinge comprises a handle hinge lock operable to releasably secure the handle hinge in the first orientation.

9. The child transportation system of claim 7, wherein the rotatable handle portion is further rotatable to a fold release position, in which movement of the handle hinge from the first position to the second position is possible, further wherein movement of the handle hinge from the first position to the second position is prevented when the rotatable handle portion is arranged in the locking position.

10. The child transportation system of claim 9, wherein the rotatable handle portion is rotatable from the height release position to the fold release position by rotating the rotatable handle portion away from the lock position, further wherein the handle release actuator further comprises a secondary lock slidable, rotatable or otherwise configurable between a lock position, in which rotation of the rotatable handle portion from the height release position to the fold release position is prevented, and a release position, in which rotation of the rotatable handle portion from the height release positon to the fold release position is possible.

11. The child transportation system of claim 10, wherein rotation of the rotatable handle portion from the height release position to the fold release position disengages the handle hinge lock via a connection member.

12. The child transportation system of claim 10, wherein the secondary lock is moveable to the release position only when the handle is arranged in a lowest possible height position.

13. The child transportation system of claim 1, further comprising a width adjustment lock operable to selectively prevent relative movement of the first and second frame portions.

14. The child transportation system of claim 13, further comprising a width adjustment release actuator operable to selectively release and engage the width adjustment lock.

15. The child transportation system of claim 14, wherein the width adjustment release actuator is positioned on the second handle portion.

16. The child transportation system of claim 15, wherein the width adjustment release actuator is rotatable between a width unlock position, in which the width lock is disengaged and relative movement of the first and second frame members is possible, and a width lock position, in which the width lock is engaged and relative movement of the first and second frame members is prevented.

17. The child transportation system of claim 1, wherein each of the first and second frame members include an upper sub portion attached to the handle, a front sub portion attached to a wheel of the front wheel set and a rear sub portion attached to a wheel of the rear wheel set, wherein each sub portion of the first and second frame members are each attached via a first and second side joint mechanism respectively.

18. The child transportation system of claim 17, wherein the first and second side joint mechanisms comprise the handle hinge, further wherein the handle is fixedly attached to the upper sub portions of the first and second frame members.

19. The child transportation system of claim 17, wherein the frame is configurable in an extended arrangement, in which the sub portions are spaced and the system is suitable for transporting an infant, and a collapsed position, in which the sub portions are adjacent along their lengths and the system is arranged for storage.

20. The child transportation system of claim 19, wherein the frame further comprise a carry handle arranged such that, with the frame in the collapsed position, the carry handle is positioned on an opposite side of the frame to the first and second wheel sets such that the system is manoeuvrable on the first and second wheel sets by pushing or pulling the carry handle.

21. The child transportation system of claim 17, wherein the front sub portion of the first frame member is attached to the front sub portion of the second frame member via a front cross member, and the rear sub portion of the first frame member is attached to the rear sub portion of the second frame member via a rear cross member, wherein the front cross member and the rear cross member are telescopically length adjustable.

22. The child transportation system of claim 21, wherein the front cross member and the rear cross member each comprise locks configured to selectively prevent length adjustment of the respective cross member.

23. The child transportation system of claim 17, wherein the side joint mechanisms comprise the infant carrier attachment mechanism.

24. The child transportation system of claim 1, wherein the infant carrier attachment mechanism comprises a protrusion configured to be received, in use, by a corresponding socket on said infant carrier module.

25. The child transportation system of claim 24, further comprising infant carrier adapters configured to be attachable to the infant carrier attachment mechanism to reduce a distance between a first side of the infant carrier attachment mechanism and a second side of the infant carrier attachment mechanism.

26. The child transportation system of claim 1, further comprising an infant carrier module configured to receive an infant therein, wherein the infant carrier module comprises a frame attachment mechanism configured to interconnect with the infant carrier attachment mechanism to releasably attach the infant carrier module to the frame or a seat.

27. The child transportation system of claim 26, wherein the frame attachment mechanism comprises a first socket on a first side of the infant carrier module and a second socket on a second side of the infant carrier module, wherein each socket is configured to receive and releasably retain a protrusion of the infant carrier attachment mechanism therein.

28. The child transportation system of claim 1, further comprising a seat portion releasably attachable to the infant carrier attachment mechanism, wherein the seat portion is configurable to, in use, provide a seat structure for an infant, further wherein the seat portion comprises a secondary attachment mechanism configured to releasably attach said infant carrier module thereto, in use.

29. The child transportation system of claim 28, wherein the seat portion comprises a bumper bar configured to be releasably attachable to the secondary attachment mechanism.

30. The child transportation system of claim 29, wherein said infant carrier module is attachable to the frame via bumper bar attachment points.

31. The child transportation system of claim 29, wherein the bumper bar is rotatably attached to the frame, the seat portion comprises a backrest bar and backrest mechanism rotatably attached to the frame and connected to the bumper bar via a gear drive, wherein the gear drive is configured such that adjustment of the bumper bar or the backrest mechanism, via the backrest bar or otherwise, moves the other of the bumper bar and the backrest bar and a relative angle between the backrest bar and the bumper bar is selectively maintained at all orientations of the bumper bar.

32. The child transportation system of claim 28, wherein the seat structure comprises a leg rest, wherein the leg rest is securable in a plurality of angular orientations relative to a lower seat member of the seat portion, further wherein, with the infant carrier module arranged on the seat structure, the leg rest is configured to wrap around. and/or cocoon the infant carrier module.

33. The child transportation system of claim 28, wherein the seat portion is arrangeable in an extended position, in which the seat structure is deployed, and a collapsed position, in which the seat structure is collapsed or stowed, further wherein the seat structure is moveable from the extended position to the collapsed position only when a secondary lock of the backrest mechanism is unlocked.

34. The child transportation system of claim 1, wherein a first front wheel of the front wheel set is releasably attached to the first frame member and a second front wheel of the front wheel set is releasably attached to the second frame member.

35. The child transportation system of claim 34, further comprising replacement front wheels having a different width and/or diameter to the first and second front wheels.

36. The child transportation system of claim 1, wherein the front and/or rear wheel sets comprise a suspension system, wherein the respective wheel is attached to the respective frame member via a wheel hinge and the suspension system comprises a dampened spring.

37. The child transportation system of claim 1, wherein the rear wheel set comprises two rear wheels connected via a rear axle, further wherein the two rear wheels are releasably attached to the frame.

38. The child transportation system of claim 37, wherein the rear is releasably attachable to the first and second frame members.

39. The child transportation system of claim 37, wherein the rear axle is width adjustable.

40. The child transportations system of claim 37, further comprising a replacement rear wheel set comprising replacement rear wheels, each having a different width and/or diameter to the rear wheels, wherein the replacement rear wheels are connected via a replacement axle or to the rear axle.

41. The child transportation system of claim 1, wherein the rear wheel set comprises a brake system operable to selectively prevent rotation of at least one rear wheel of the rear wheel set.

42. The child transportation system of claim 1, further comprising a basket configurable in a narrow orientation, wherein the basket has a first width, and a wide orientation, wherein the basket has a second width greater than the first width.
